(19) United States
(12) Patent Application Publication
(10) Pub. No.: US 2012/0300051 A1
(43) Pub. Date: Nov. 29, 2012

(54) IMAGING APPARATUS, AND DISPLAY METHOD USING THE SAME

(76) Inventors: Kenji DAIGO, Sayama-shi (JP); Manabu YAMADA, Yokohama-shi (JP)

(21) Appl. No.: 13/480,935

(22) Filed: May 25, 2012

(30) Foreign Application Priority Data
May 27, 2011 (JP) 2011-118838
Jan. 18, 2012 (JP) 2012-007770

(51) Int. Cl. H04N 7/18; H04N 5/222

(52) U.S. Cl. 348/77; 348/333.01; 348/E07.085; 348/E05.022

(57) ABSTRACT

An imaging apparatus includes: a first imaging optical system that obtains a first photographic subject image; a second imaging optical system that is capable of obtaining a second photographic subject image which is more telephoto than the first photographic subject image obtained by the first imaging optical system; a first imaging section that converts an image signal of the first photographic subject image into first image data; a second imaging section that converts an image signal of the second photographic subject image into second image data; a display that displays the first photographic subject image by the first image data and the second photographic subject image by the second image data; and a controller that controls the display such that an indicator frame that indicates an imaging range of the second photographic subject image is displayed in the first photographic subject image displayed on the display.

### CROSS-REFERENCE TO RELATED APPLICATIONS

The present application is based on and claims priority from Japanese patent application numbers 2011-118838, filed May 27, 2011, and 2012-007770, filed Jan. 18, 2012, the disclosures of which are hereby incorporated by reference in their entireties.

### BACKGROUND

The present invention relates to improvement of an imaging apparatus such as a compact digital camera or the like, and of a display method using the imaging apparatus.

In recent years, a compact digital camera having a high-magnification zoom lens an optical zoom magnification of which exceeds 10× has been developed and available to consumers.

Additionally, for example, a digital camera having equal to or more than two optical systems such as a 3D camera, or a camera having a phase-difference detection type AF sensor has been also developed.

Incidentally, in a digital camera having a high-magnification zoom lens, when its optical system is set in a vicinity of a maximum telephoto side, there is a problem such that it is difficult to set all desired photographic subjects in a range of an angle of view.

Therefore, a digital camera has been proposed such that in zoom-shooting, in order to make operation easy when a user shoots a specific photographic subject (a desired main photographic subject), a wide-angle image and a telephoto image (an image obtained by the zoom-shooting) are taken at the same time, the wide-angle image is displayed entirely on a display, and an imaging range corresponding to the telephoto image (the image obtained by the zoom-shooting) is displayed to be surrounded by an indicator frame (See Japanese patent application publication number 2009-244369).

In addition, when shooting is performed in a state where the optical system is set on a telephoto side looking at an optical viewfinder, in order to prevent missing a desired main photographic subject, an imaging apparatus that prohibits a digital zoom function from operating has been also proposed (See Japanese patent application publication number 2003-274253).

According to the digital camera disclosed in Japanese patent application publication number 2009-244369, there is an advantage such that it is possible to track a photographic subject easily when zoom-shooting.

However, the digital camera disclosed in Japanese patent application publication number 2009-244369 has a problem such that a driving mechanism of an optical system becomes complex. And additionally, the digital camera disclosed in Japanese patent application publication number 2003-274253 has a problem such that a digital zoom function is not utilized.

### SUMMARY

An object of the present invention is to provide an imaging apparatus that is capable of setting a desired photographic subject in a range of an angle of view in high-magnification shooting by having equal to or more than two optical systems, where one is set to obtain a wide-angle image, and the other is set to obtain a telephoto image, and displaying a relationship between the wide-angle image and the telephoto image on a monitor screen of a display.

In order to achieve the object, an embodiment of the present invention provides: an imaging apparatus comprising: a first imaging optical system that obtains a first photographic subject image; a second imaging optical system that is capable of obtaining a second photographic subject image which is more telephoto than the first photographic subject image obtained by the first imaging optical system; a first imaging section that converts an image signal of the first photographic subject image obtained by the first imaging optical system into first image data; a second imaging section that converts an image signal of the second photographic subject image obtained by the second imaging optical system into second image data; a display that displays the first photographic subject image by the first image data and the second photographic subject image by the second image data; and a controller that controls the display such that an indicator frame that indicates an imaging range of the second photographic subject image is displayed in the first photographic subject image displayed on the display.

In order to achieve the object, an embodiment of the present invention provides: a method of display used for an imaging device including: a first imaging optical system that obtains a first photographic subject image; a second imaging optical system that is capable of obtaining a second photographic subject image which is more telephoto than the first photographic subject image obtained by the first imaging optical system; a first imaging section that converts an image signal of the first photographic subject image obtained by the first imaging optical system into first image data; a second imaging section that converts an image signal of the second photographic subject image by the first imaging optical system into second image data; a display that displays the second photographic subject image by the second image data; a controller that controls the display such that an indicator frame that indicates an imaging range of the second photographic subject image is displayed on the first photographic subject image; and a photographic subject-determining device that determines a photographic subject as a target from the first image data obtained by the first imaging optical system, the method comprising the steps of: displaying the second photographic subject image obtained by the second imaging optical system; determining a photographic subject as a target from the first photographic subject image by the photographic subject-determining device; and displaying a pointer such that when at least a part of the target becomes outside of the second photographic subject image, the pointer that indicates a direction where the target exists is displayed on the display.

### BRIEF DESCRIPTIONS OF THE DRAWINGS

FIG. 1 is an external diagram illustrating an example of a 3D camera used in an imaging apparatus according to an embodiment of the present invention.

FIG. 2 is a block diagram of a control circuit of the 3D camera illustrated in FIG. 1.

FIG. 3 is an explanatory diagram of an imaging apparatus according to Embodiment 1, and illustrates an example of a relationship between a wide-angle image and a telephoto image obtained by the 3D camera illustrated in FIG. 1.

FIG. 4 is an explanatory diagram illustrating a telephoto image as a desired photographic subject.

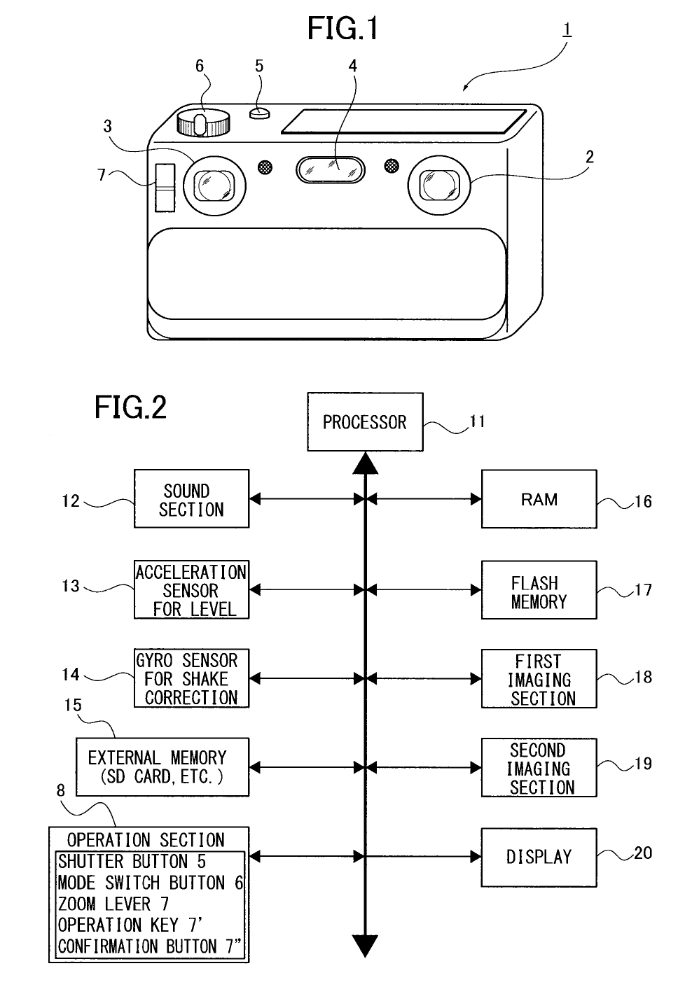

Each of FIGS. 5A to 5C is an explanatory diagram according to Embodiment 2. FIG. 5A is an explanatory diagram illustrating a state where a target in a wide-angle image obtained by a left-sided imaging optical system illustrated in FIG. 1 is locked. FIG. 5B is an explanatory diagram of an example in which a pointer is displayed in a corner of a display screen when there is no desired photographic subject in a telephoto image obtained by a right-sided imaging optical system illustrated in FIG. 1. FIG. 5C is an explanatory diagram of an example in which a pointer is displayed in the center of the display screen when there is no desired photographic subject in a telephoto image obtained by the right-sided imaging optical system illustrated in FIG. 1.

FIG. 6 is an explanatory diagram of an imaging apparatus according to Embodiment 3, and illustrates an example in which when a telephoto image is displayed, a wide-angle image is displayed as a sub-image, and in an area where the sub-image is displayed a range corresponding to an area where the telephoto image is displayed is displayed by an indicator frame.

FIG. 7 is an external diagram illustrating an example of a phase-difference detection type camera used in an imaging apparatus according to an embodiment of the present invention.

FIG. 8 is a block diagram of a control circuit of the phase-difference detection type camera illustrated in FIG. 7.

FIG. 9 is an explanatory diagram of a difference in position between the center of the optical axis of a first imaging optical system and the center of the optical axis of a second imaging optical system.

FIG. 10 is an explanatory diagram illustrating an amount of difference in position between the center of an angle of view of a wide-angle image and the center of an angle of view of a telephoto image.

Each of FIGS. 11A and 11B is an explanatory diagram illustrating a selection menu screen as a setting menu screen according to an embodiment of the present invention. FIG. 11A is an example of items of the selection menu screen. FIG. 11B illustrates a state where an item of “F assistance” is selected in the selection menu screen illustrated in FIG. 11A.

Each of FIGS. 12A to 12C is an explanatory diagram of a digital camera according to Embodiment 5 of the present invention. FIGS. 12A, 12B, and 12C are a front view, a top view, and a rear view of the digital camera, respectively.

FIG. 13 is a block diagram illustrating an outline of a system constitution of the digital camera illustrated in FIGS. 12A to 12C.

Each of FIGS. 14A and 14B is an example where a monitoring image obtained by a main imaging optical system, and a monitoring image obtained by an assistant imaging optical system are displayed at the same time on a display screen of an LCD illustrated in FIG. 12C. FIG. 14A is a diagram illustrating a monitoring image in a case where a focal length of the main imaging optical system and a focal length of the assistant-imaging optical system are approximately equal. FIG. 14B is a diagram illustrating a monitoring image in a case where the focal length of the main imaging optical system is longer than the focal length of the assistant imaging optical system.

FIG. 15 is a flow diagram for explaining steps of a direction display of a main photographic subject.

Each of FIGS. 16A to 16D is an example of a guide indicator that indicates a direction where a main photographic subject exists with respect to a monitoring image obtained by a main imaging optical system. FIG. 16A is a diagram illustrating an example where the main photographic subject is set in an angle of view of the main imaging optical system, and the guide indicator is not displayed. FIG. 16B is a diagram illustrating an example where a direction where the main photographic subject exists is displayed as an arrow as the guide indicator, because the main photographic subject is not set in the angle of view of the main imaging optical system. FIG. 16C is a diagram illustrating an example of the guide indicator that is displayed as a shaded area in a right edge of a display screen in place of the arrow illustrated in FIG. 16B. FIG. 16D is a diagram illustrating an example where only an arrow that indicates a direction where the main photographic subject exists is displayed as a guide indicator when a monitoring image by the assistant imaging optical system is not displayed on the display screen of an LCD, and the main photographic subject becomes outside of the monitoring image of the main imaging optical system.

Each of FIGS. 17A and 17B is an explanatory diagram illustrating an example of a guide indicator in a case where a plurality of faces of persons is detected. FIG. 17A illustrates a case where a face as a main photographic subject is set in the monitoring image by the main imaging optical system. FIG. 17B illustrates a case where a face that is not the main photographic subject is set in the monitoring image by a main imaging optical system; however, the face as the main photographic subject is not set in the monitoring image by the main imaging optical system.

FIG. 18 is a flow diagram for explaining operation of a digital camera according to Embodiment 6 of the present invention.

Each of FIGS. 19A and 19B is an explanatory diagram of a monitoring image displayed on the display screen of the LCD according to Embodiment 6 of the present invention. FIG. 19A illustrates a state where an assistant-monitoring image is displayed small in a corner of the display screen of the LCD when a user does not perform a selection of a main photographic subject. FIG. 19B illustrates a state where an enlarged assistant monitoring image is displayed when the user performs the selection of the main photographic subject.

### DETAILED DESCRIPTIONS OF THE PREFERRED EMBODIMENTS

Hereinafter, a digital camera to which an imaging apparatus according to embodiments of the present invention is applied will be explained with reference to the drawings.

### Embodiment 1

FIG. 1 illustrates an external view of a digital camera 1 according to Embodiment 1 of the present invention. Here, a 3D camera composes the digital camera 1.

The digital camera 1 generally includes a left-sided imaging optical system 2 as a first imaging optical system, a right-sided imaging optical system 3 as a second imaging system, a flash 4, a shutter button 5, a mode switch button 6, a zoom lever 7, and so on.

The optical constitutions of the left-sided imaging optical system 2 and the right-sided imaging optical system 3 are the same.

The shutter button 5, the mode switch button 6, the zoom lever 7, an operation key 7′ and a confirmation button 7″ illustrated in FIG. 2, and the like are included in an operation section 8 illustrated in FIG. 2.

The shutter button 5 is used when shooting is performed, and the mode switch button 6 is used for mode switching of a still image shooting mode, a moving image shooting mode, and the like, for example.

The zoom lever 7 is used for changing a zoom magnification. The operation key 7′ is used for various operations such as display of a menu screen, playback of a recorded image, and also moving a cursor on a later-described display screen GU of a display section 20, for example. The confirmation button 7″ is used for confirmation of an execution result by a software program.

Here, the left-sided imaging optical system 2 is fixed in a wide end, and obtains a first photographic subject image. The right-sided imaging optical system 3 is set on a more telephoto side than the left-sided imaging optical system 2, and obtains a second photographic subject image which is more telephoto than the first photographic subject image. The left-sided imaging optical system 2 is used for display of a wide-angle image as the first photographic subject image, and the right-sided imaging optical system 3 is used for display of a telephoto image as the second photographic subject image. However, the left-sided imaging optical system 2 can be used for the display of the telephoto image, and the right-sided imaging optical system 3 can be used for the display of the wide-angle image.

In any case, an angle of view of the first imaging optical system is larger than an angle of view of the second imaging optical system.

FIG. 2 is a block circuit diagram of the digital camera 1.

The block circuit of the digital camera 1 generally includes a processor 11 as a controller, a sound section 12, an acceleration sensor 13 for a level, a gyro sensor 14 for shake correction, an external memory (SD card) 15, an internal memory (RAM) 16, a flash memory 17, a first imaging section 18, a second imaging section 19, and a display 20.

Those generally known are used as the sound section 12, the acceleration sensor 13 for the level 13, the gyro sensor 14 for shake correction, the external memory (SD card) 15, the internal memory (RAM) 16, the flash memory 17 and so on.

The first imaging section 18 functions to convert an image signal of a first photographic subject image obtained by the first imaging optical system into first image data. The second imaging section 19 functions to convert an image signal of a second photographic subject image obtained by the second imaging optical system into second image data.

The display 20 is provided on a rear surface of a body of the digital camera 1. On the display 20, the first photographic subject image of the first image data and the second photographic subject image of the second image data are displayed.

The processor 11, while monitoring a photographic subject, functions as a controller such that an indicator frame that indicates an imaging range of the second photographic subject image of the second image data is displayed in the first photographic subject image of the first image data displayed on the screen of the display 20.

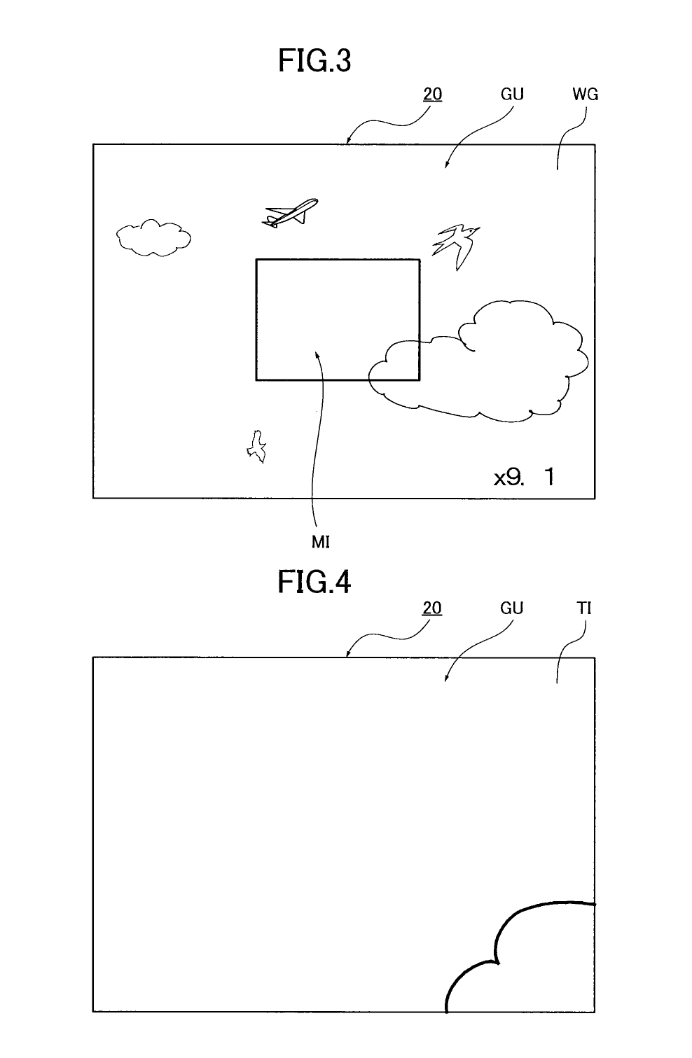

That is, while monitoring the photographic subject, the processor 11 controls the display 20 such that a wide-angle image WG based on the first image data is displayed entirely on a display screen GU of the display 20 as illustrated in FIG. 3, and an indicator frame MI that indicates a range of a telephoto image TI based on the second image data is displayed on the display screen GU of the display 20.

The processor 11 performs control to change the size of the indicator frame MI to the size corresponding to a zoom magnification by a zoom operation of the zoom lever 7. Here, the size of the indicator frame MI corresponds to 9.1× zoom magnifications. The larger the zoom magnification becomes, the smaller the indicator frame MI is displayed on the display screen GU.

The setting of switching of a monitoring screen from display of the wide-angle image WG to display of the telephoto image TI is performed by a selection menu screen GU′ of a setting menu screen illustrated in FIG. 11. On the display screen GU of the display 20, the selection menu screen GU′ as the setting menu screen is displayed.

Here, on the selection menu screen GU′, as illustrated in FIG. 11A, each item of “Picture Quality/Size”, “Focus”, “Pre AF”, “F Assistance”, “Exposure Metering”, “Image Setting”, and so on is displayed. When the operation key 7′ is operated and the item of “F Assistance” is selected as illustrated in FIG. 11B, on the selection menu, each of “OFF”, “ON”, “Arrow left below”, “Arrow in the center”, and “PIP” is displayed.

In a state where those above are displayed, on the selection menu screen GU′, when the operation key 7′ is operated, “ON” is selected, and the confirmation button 7″ is operated, a later-explained function in Embodiment 1 is executed. When “Arrow left below” or “Arrow in the center” is selected, a later-explained function in Embodiment 2 is executed, and when “PIP” is selected, a later-explained function in Embodiment 3 is executed.

In Embodiment 1, on the selection menu screen GU′, “ON” is selected beforehand.

In Embodiment 1, specifically, the processor 11 controls the display 20 to display the wide-angle image WG on the display screen GU when magnification is at 1× magnification. For example, when the magnification exceeds 5× magnification by the zoom operation of the zoom lever 7, the processor 11 controls the display 20 to entirely display the second photographic subject image based on the second image data in the indicator frame MI on the display screen GU of the display 20.

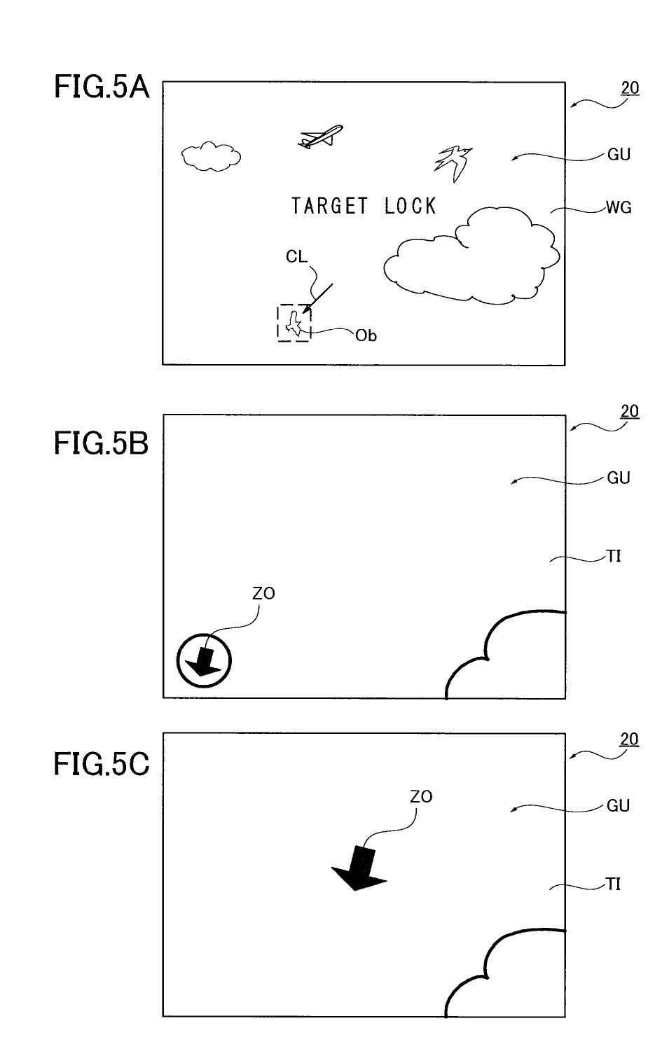

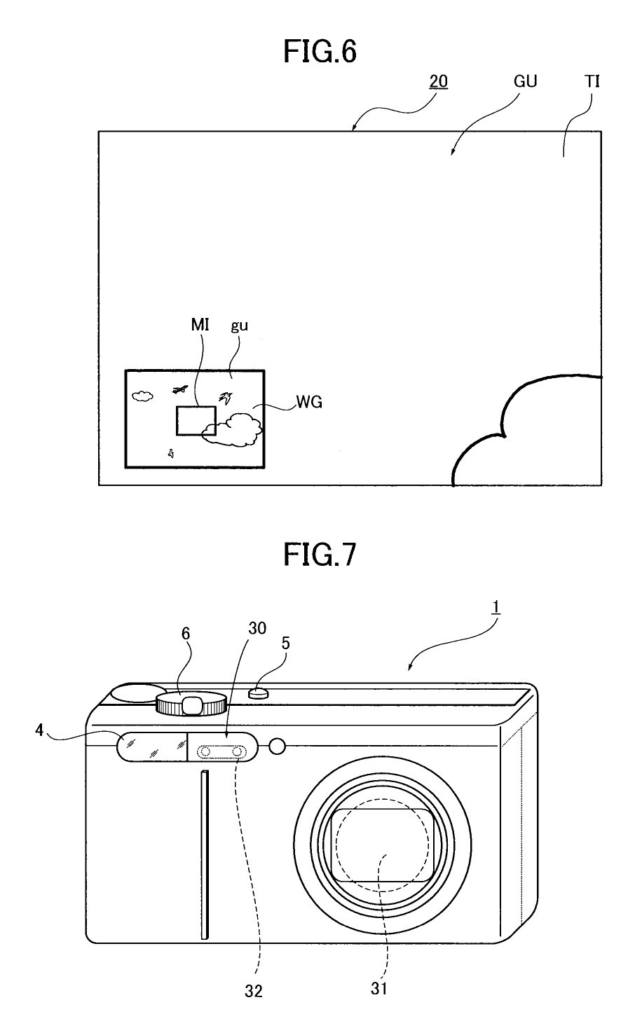

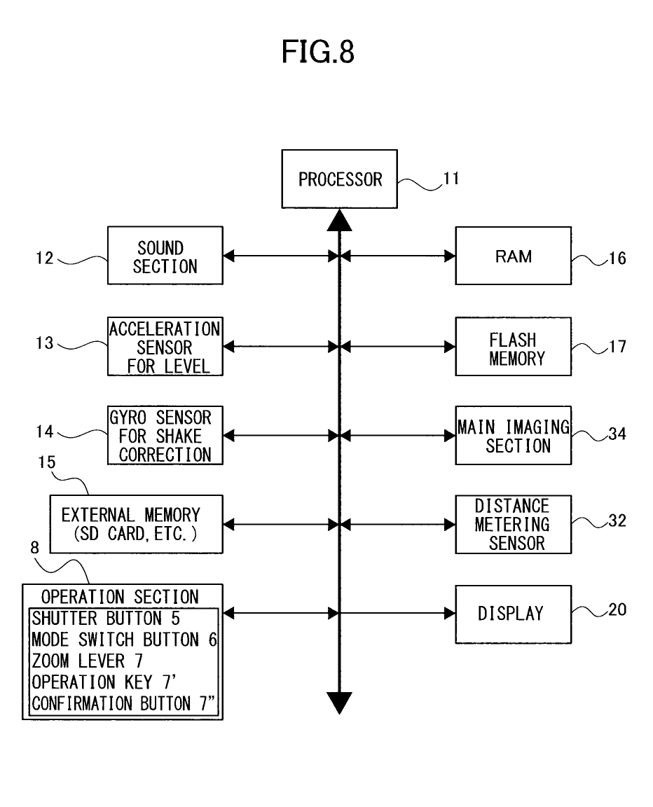

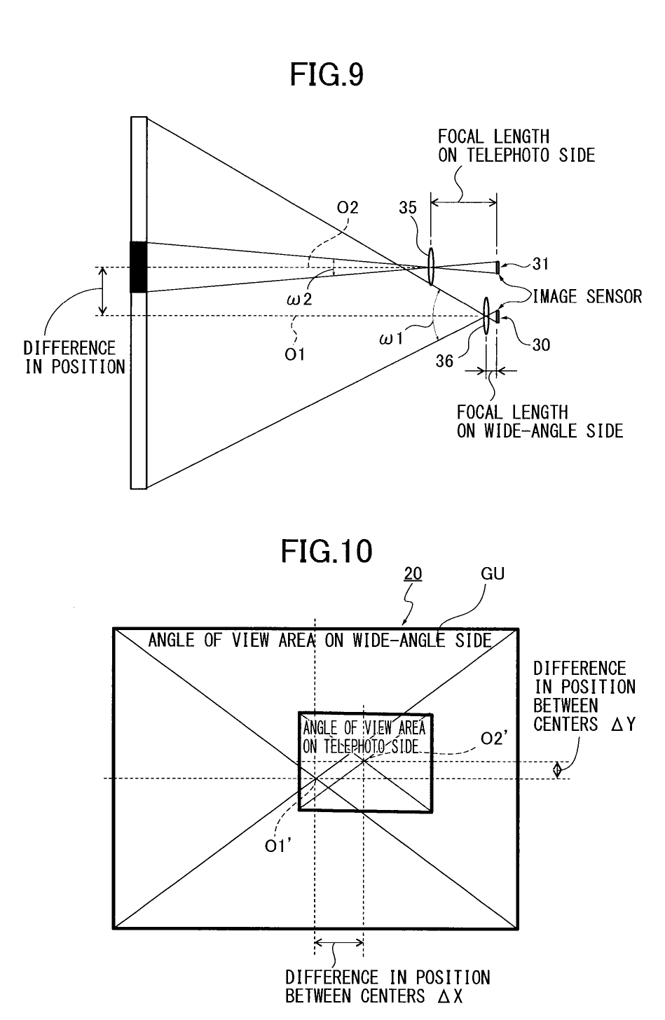

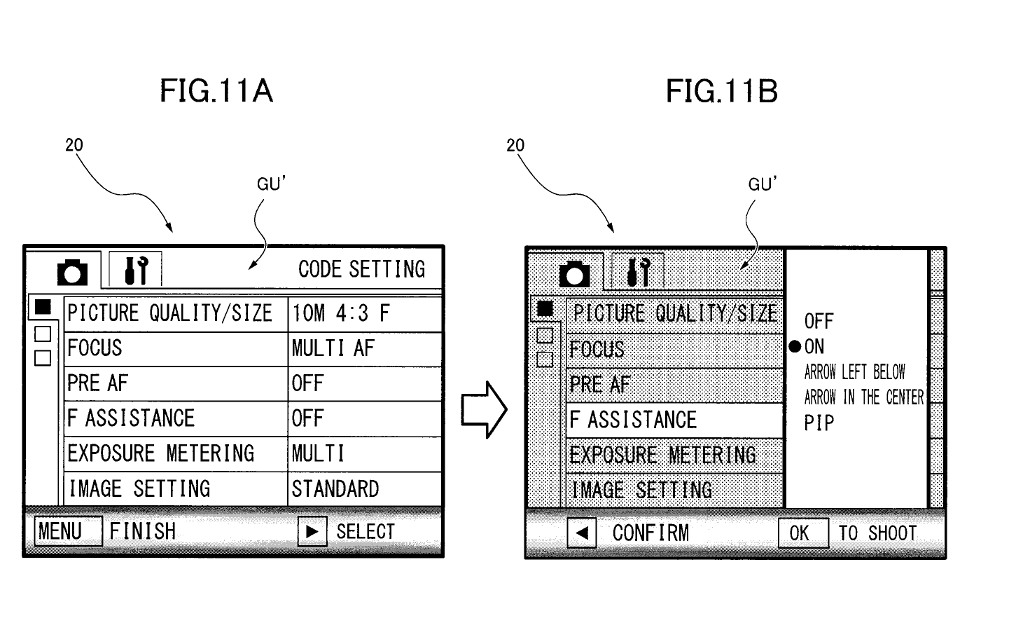

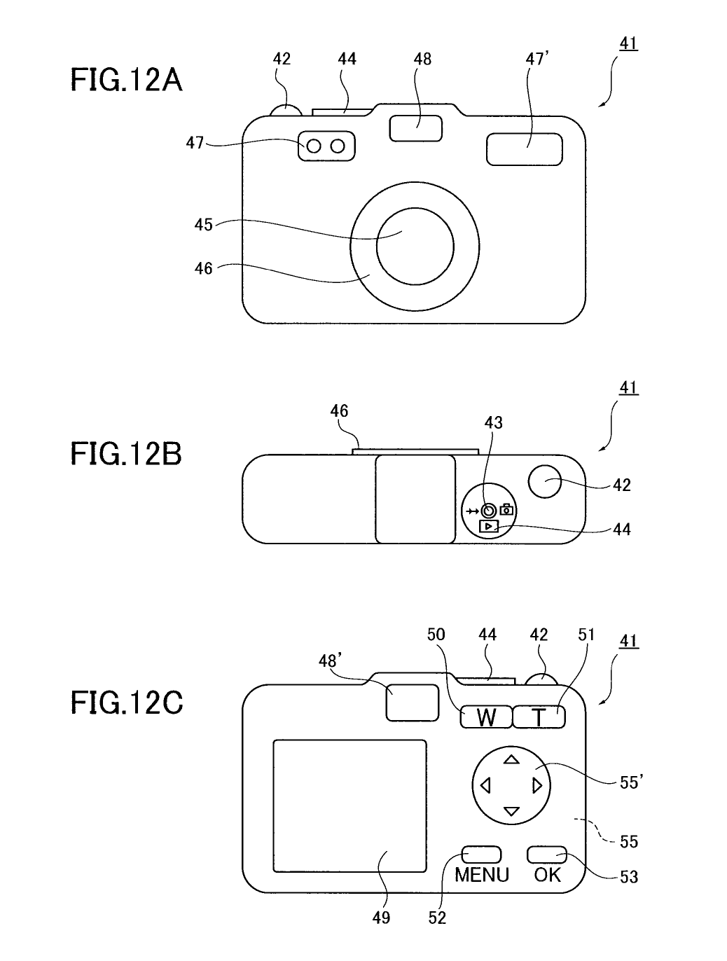

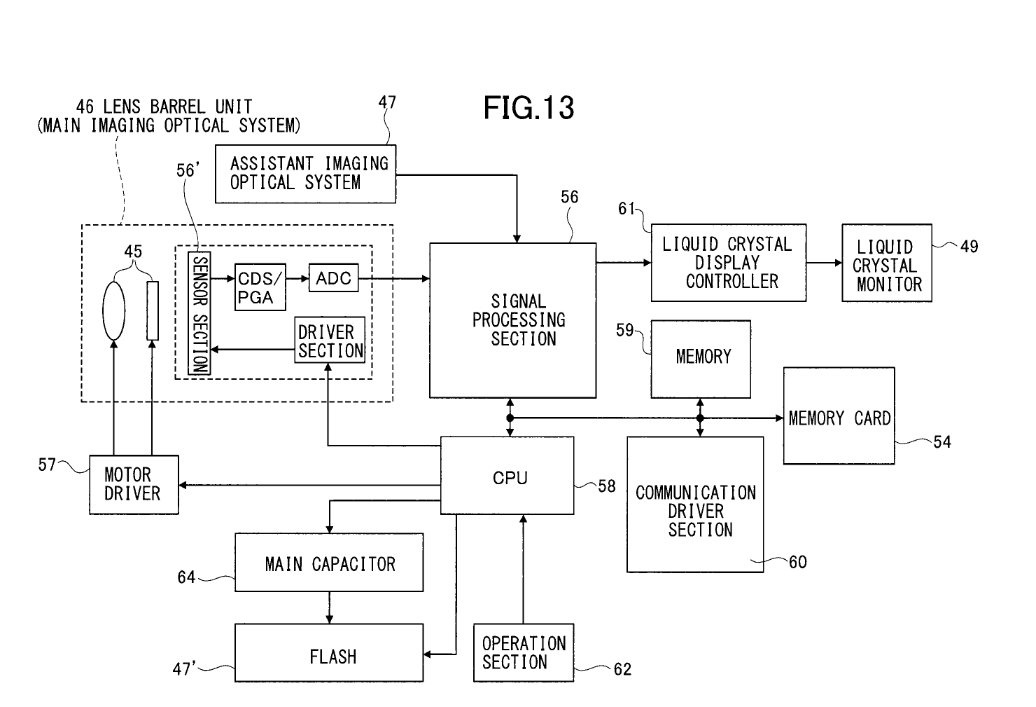

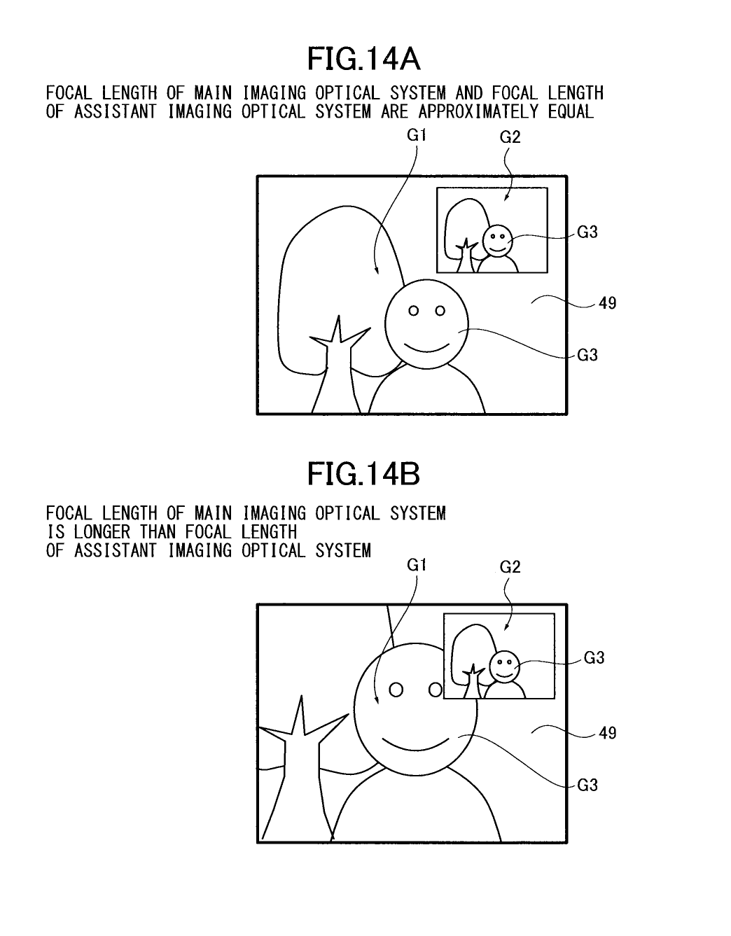

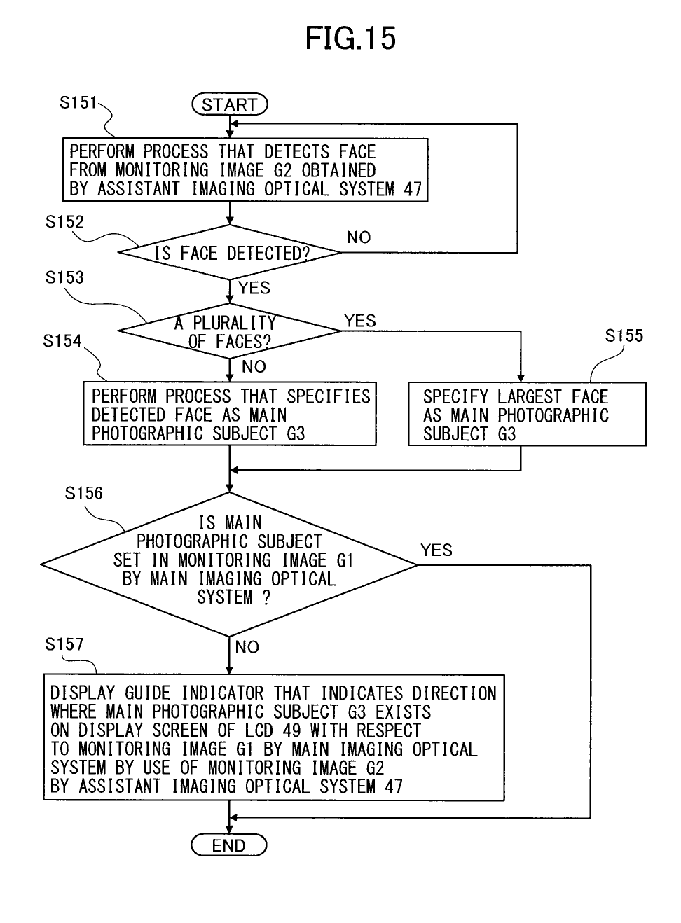

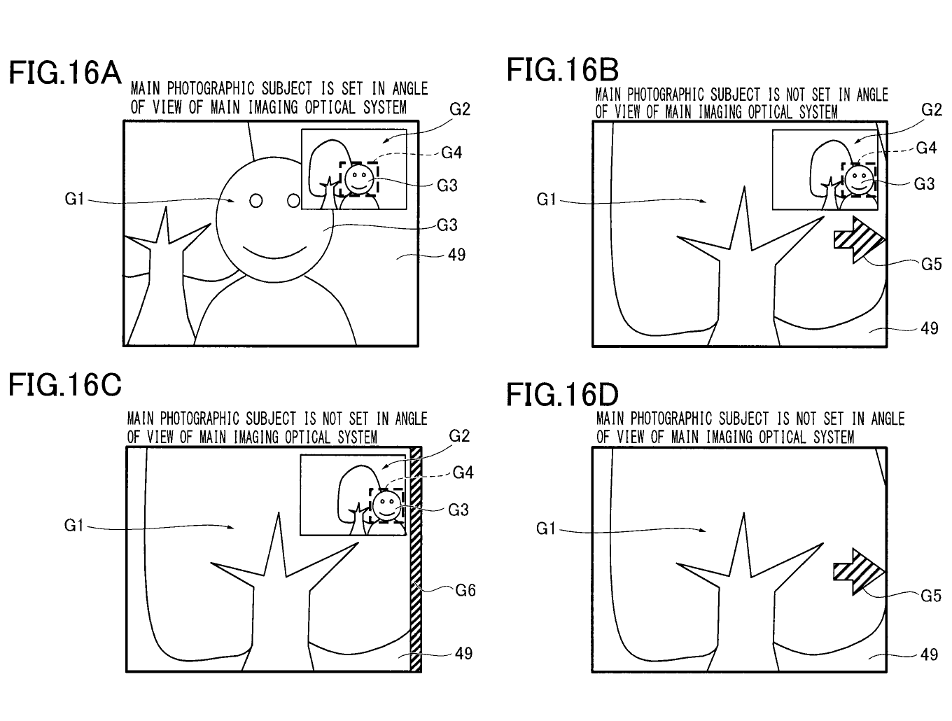

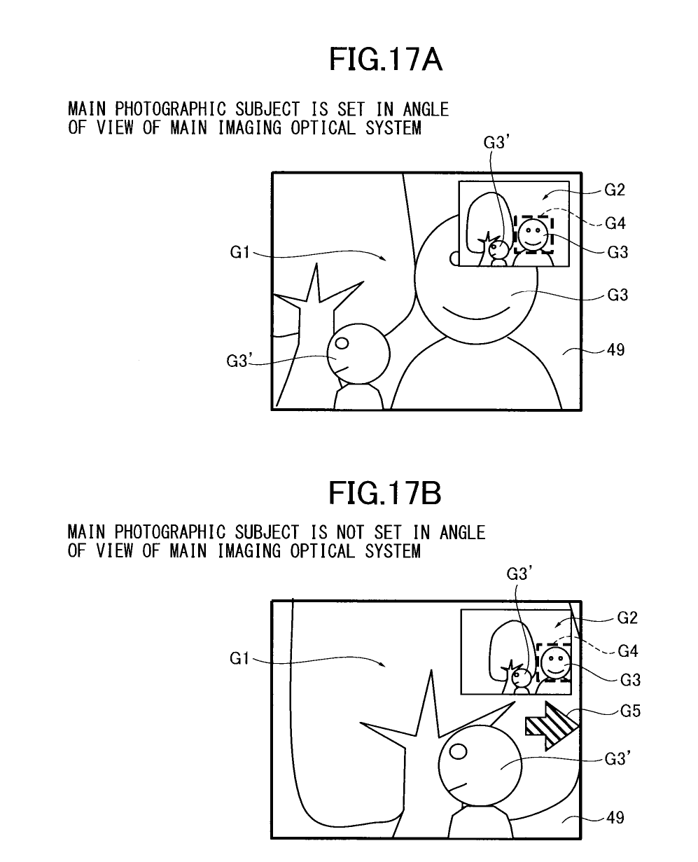

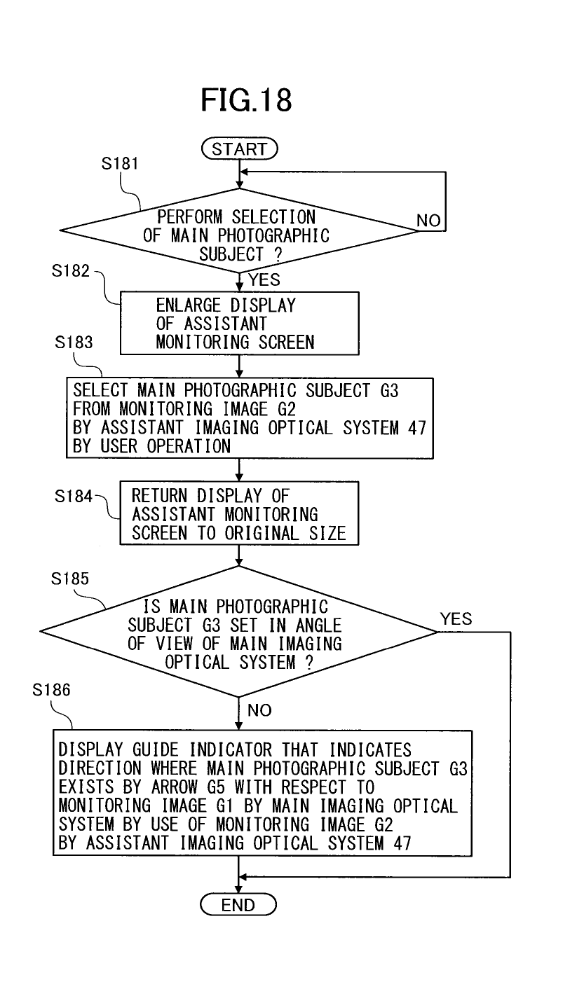

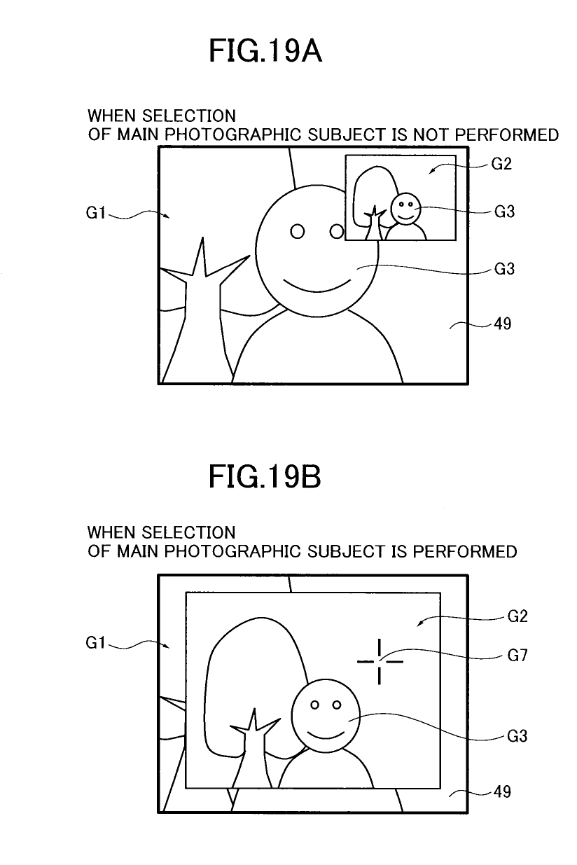

Here, as illustrated in FIG. 4, a part of a cloud as the second photographic subject image based on the second image data is entirely displayed on the display screen GU of the display 20.

According to Embodiment 1, even if a photographic subject is difficult to be set in an angle of view in telephoto shooting, it is easily possible to set the photographic subject in a range of an angle of view in wide-angle shooting, and therefore it is easily possible to set a desired photographic subject in a range of an angle of view looking at the image of the photographic subject in the wide-angle shooting.

### Embodiment 2

In Embodiment 2, when a target that exists in the first photographic subject image by the first image data is locked, and display of the display 20 is switched to the second photographic subject image by the second image data, the processor 11 controls the display 20 to display a pointer that indicates a direction where the target exists.

In Embodiment 2, in the selection menu screen GU′ illustrated in FIG. 11B, “Arrow left below”, or “Arrow in the center” is selected beforehand.

FIGS. 5A illustrates an example of a wide-angle image of Embodiment 2. While monitoring a photographic subject, as illustrated in FIG. 5A, on the display screen GU of the display 20, the first photographic subject image as a wide-angle image based on the first image data is entirely displayed.

That is, in Embodiment 2, in a state where a telephoto image TI based on the second image data is displayed on the display 20, by a long-press of a Fn (function) button (not illustrated), the processor 11 controls the display 20 such that a wide-angle image WG based on the first image data is displayed on the display screen GU. That is, the processor 11 functions as a photographic subject-determining device to determine a photographic subject as a target from the first photographic subject image obtained by the first imaging optical system.

The processor 11 has a function to move a cursor CL on the display screen GU of the display 20 illustrated in FIG. 5A while tracking the target. And similar to tracking a photographic subject (Pre AF), when a long-press of the shutter button 5 is performed, the processor 11 has a function to lock a target Ob as the target Ob is considered to exist in a position determined by the cursor CL.

Here, as illustrated in FIG. 5A, a bird is determined as the target Ob. The target Ob is surrounded by a frame and displayed.

When the target Ob is locked, the processor 11 controls the display 20 to automatically switch such that the second photographic subject image of the second image data is displayed entirely on the display screen GU of the display 20.

When a state where a wide-angle image is displayed entirely on the display screen GU of the display 20 is switched to a state where a telephoto image is displayed and the target Ob does not exist in the telephoto image, as illustrated in FIG. 5B, the processor 11 has a function to display an arrow ZO as a pointer that indicates a direction where the target Ob exists.

That is, in a case where the locked target Ob is displayed in the wide-angle image WG on the display screen GU of the display 20, the processor 11 controls the display 20 such that the arrow ZO that indicates a direction of the locked target Ob from the center of the telephoto image TI obtained by the right-sided imaging optical system 3 is displayed on the display screen GU on which the telephoto image TI is displayed.

In a case where the target Ob exists in the telephoto image TI obtained by the right-sided imaging optical system 3, the processor 11 controls the display 20 to display “TARGET LOCK” that informs the locked target Ob exists in the telephoto image TI on the display screen GU of the display 20 in which the wide-angle image WG is displayed, or not to display the arrow ZO.

On the selection menu screen GU′, in a case where “Arrow left below” is selected, as illustrated in FIG. 5B, the arrow ZO is displayed in a corner of the display screen GU. On the selection menu screen GU′, in a case where “Arrow in the center” is selected, as illustrated in FIG. 5C, the arrow ZO is displayed in the center of the display screen GU. However, a display position of the arrow ZO on the display screen GU is not limited thereto, and it is preferable to point a camera in the direction where the target Ob exists.

In order to visually recognize how much the camera needs to move until a desired telephoto image is entirely displayed on the display screen GU, it is preferable to display a relationship of a movement of the camera to the target Ob that is desired by changing the length of the arrow ZO.

Additionally, in a case where the digital camera 1 has a tracking auto focus function and when the once-locked target Ob disappears from a tacking area, it is preferable to display a message that informs a user that the locked target Ob becomes outside of the tracking area on the display screen GU of the display 20, or to display nothing on the display screen GU of the display 20.

In addition, in a case where the once-locked target Ob becomes outside of the tracking area, it is preferable to display a direction that is locked finally on the display screen GU of the display 20.

Furthermore, in a case where the target is once out of the tracking area and enters the tracking area again, it is preferable to display the arrow ZO or display of “TARGET LOCK” again.

However, in this case, if a target is a bird, an airplane, or the like, and a plurality of targets of the same kind exists in the tracking area, and the target becomes outside of the tracking area once and enters the tracking area again, it is difficult to determine if the target is the same or not.

Therefore, in such a case, a display showing that the target is indistinguishable may be shown.

### Embodiment 3

In Embodiment 3, when a telephoto image by the second image data is displayed on the display 20, the processor 11 controls the display 20 to display a wide-angle image by the first image data as a sub-image, and in an area where the sub-image is displayed, an imaging range corresponding to the telephoto image is displayed as an indicator frame.

In Embodiment 3, in the selection menu screen GU′ illustrated in FIG. 11B, “PIP” is selected beforehand.

FIG. 6 illustrates an example of display of the telephoto image of Embodiment 3, and while monitoring a photographic subject, a photographic subject image as the telephoto image based on the second image data is entirely displayed on the display screen GU of the display 20.

In a part of the display screen GU of the display 20, a wide-angle image by the first image data is displayed as a sub-image gu. In an area of the sub-image gu, a range corresponding to the telephoto image is displayed as an indicator frame MI.

Thus, in Embodiment 3, in a state where the telephoto image TI based on the second image data is entirely displayed on the display screen GU of the display 20, the wide-angle image based on the first image data is displayed by a method of a so-called “Picture in Picture (PIP)”.

In Embodiment 3, while monitoring the telephoto image TI, since a relationship between the telephoto image TI and the wide-angle image WG is displayed by the indicator frame MI, it is possible for the user to directly and easily recognize the relationship between the wide-angle image WG and the telephoto image TI even on a monitoring screen of the display 20.

### Embodiment 4

In Embodiment 4, a digital camera 1 is a phase-difference detection type camera. The digital camera 1, as illustrated in FIG. 7, includes an optical system for distance metering 30 as a first imaging optical system, a main imaging optical system 31 as a second imaging optical system, a flash 4, a shutter button 5, a mode switch button 6, a zoom lever, and so on.

An operation section 8 illustrated in FIG. 8 includes the shutter button 5, the mode switch button 6, the zoom lever, and so on. Functions of the shutter button 5, the zoom lever, and so on are the same as those in Embodiment 1.

The mode switch button 6 is used for mode switching such as a still image shooting mode, a movie shooting mode, and so on, for example.

The optical system for distance metering 30 constitutes a part of a distance metering sensor 32 of a phase-difference detection type (See FIG. 8) including two image sensors (area sensors) such as a CCD image sensor, a CMOS image sensor, or the like.

The optical system for distance metering 30 is used for metering a distance to a photographic subject and displaying a wide-angle image. The main imaging optical system 31 has a main imaging section 34 (See FIG. 8), and is used for displaying a wide-angle image and a telephoto image.

FIG. 8 is a block diagram of the digital camera 1.

The block diagram of the digital camera 1, similar to the control circuit block illustrated in FIG. 2, includes a processor 11, a sound section 12, an acceleration sensor 13 for a level, a gyro sensor 14 for shake correction, an external memory (SD card) 15, an internal memory (RAM) 16, a flash memory 17, and a display 20.

Those generally known are used for the sound section 12, the acceleration sensor 13 for the level, the gyro sensor 14 for shake correction, the external memory (SD card) 15, the internal memory (RAM) 16, the flash memory 17, and so on.

The distance metering sensor 32 functions to convert an image signal of a photographic subject obtained via the optical system for distance metering 30 into first image data.

The main imaging section 34 functions to convert an image signal of a photographic subject obtained via the main imaging optical system 31 into second image data.

The processor 11, and the display 20 have the same functions as those in Embodiment 1.

As described above, the two image sensors are used for the optical system for distance metering 30; however, one of the two image sensors can be used for the first image data.

Incidentally, as illustrated in FIG. 7, since positions of the optical system for distance metering 30 and the main imaging optical system 31 are shifted to each other in a horizontal direction and a vertical direction, an optical axis O1 (See FIG. 9) of the optical system for distance metering 30 and an optical axis O2 (See FIG. 9) of the main imaging optical system 31 are also shifted to each other in a horizontal direction and a vertical direction. Therefore, as illustrated in FIG. 10, regarding positions of a center O1′ of an angle of view area on a wide-angle side and a center O2′ of an angle of view area on a telephoto side, a difference in position in the horizontal direction ΔX and a difference in position in the vertical direction ΔY occur.

Accordingly, it is preferable to use an image sensor of the optical system for distance metering 30 that is arranged on a side closer to the main imaging section 34 to obtain the first image data in making the differences in position between the center O1′ of the angle of view on the wide-angle side and the center O2′ of the angle of view of the telephoto side with respect to the center O2′ of the angle of view on the telephoto side smaller.

In FIG. 9, reference number 35 denotes a main shooting lens, reference number 36 denotes a lens for distance metering, reference sign ω1 denotes an angle of view on a wide-angle side, and reference sign ω2 denotes an angle of view on a telephoto side.

Thus, according to the above-described embodiments, by adding a software program to a commercially available 3D camera and phase-difference detection type camera later, even in a case of high-magnification zoom shooting, it is possible to easily capture, for example, a bird flying in the sky, a flying object such as an air plane, or the like, and set it in an angle of view.

Additionally, by mounting a software program on a so-called commercially available 3D camera or phase-difference detection type camera, it is possible to set a desired photographic subject in a range of an angle of view in high-magnification zoom shooting. Therefore, without changing hardware constitutions such as a mechanical constitution, an optical constitution, and the like, that is, without developing a special camera, it is possible to set a desired photographic subject in an angle of view in high-magnification shooting.

Hereinbefore, Embodiments 1 to 4 have explained that each of the left-sided imaging optical system (first imaging optical system) 2 and the right-sided imaging optical system (second imaging optical system) 4 includes an optical zoom lens, and the left-sided imaging optical system 3 is fixed; however, it is preferable that at least the second imaging optical system include the optical zoom lens.

Additionally, a fixed-magnification imaging optical system constitutes each of the left-sided imaging optical system (first imaging optical system) 2 and the right-sided imaging optical system (second imaging optical system) 3, and at least the second image data obtained by the second imaging section 19 (See FIG. 2) can also be an enlarged image by a digital zoom function.

### Embodiment 5

Each of FIGS. 12A to 12C is an explanatory diagram of a digital camera according to Embodiment 5, and FIG. 12A, FIG. 12B, FIG. 12C are a front view, a top view, and a rear view of the digital camera, respectively.

FIG. 13 is a block diagram illustrating an outline of a system constitution of the digital camera illustrated in FIGS. 12A to 12C.

### [External Constitution of Digital Camera]

In FIGS. 12A to 12C, reference number 41 denotes a digital camera. On a top side, a shutter button 42, a power button 43, a shooting/playback switch dial 44 are provided.

On a front side of the digital camera 41, a lens barrel unit 46 having a shooting lens system 45 (element that constitutes a part of a later-described main imaging optical system), a flash 47′, an optical viewfinder 48 equivalent to the optical system for distance metering 30 in Embodiment 4, an assistant imaging optical system 47 are provided.

On a rear side of the digital camera 41, a liquid crystal monitor (LCD) 49, an eyepiece lens part 48′ of the optical viewfinder 48, a wide-angle zoom (W) switch 50, a telephoto zoom (T) switch 51, a menu (MENU) button 52, a confirmation button (OK button) 53, and the like are provided. Additionally, in an inner part on a side of the digital camera, a memory card storage 55 that stores a memory card 54 (See FIG. 13) for storing shot image data is provided.

In FIG. 13, reference number 62 denotes an operation section that is operable by a user, and the operation section 62 includes the shutter button 42, the power button 43, the shooting/playback switch dial 44, the wide-angle zoom (W) switch 50, the telephoto zoom (T) switch 51, the menu (MENU) button 52, the confirmation button (OK button) 53, and the like. An instruction signal from the operation section 62 is inputted in a CPU 58 as a controller.

### [System Constitution of Digital Camera]

As illustrated in FIG. 13, the digital camera 41 includes the shooting lens system 45 (including a shooting lens, an aperture unit, and a mechanical shutter unit), a sensor section (for example, a CMOS as a solid-state image sensor) 56′, a block circuit section, a signal processing section 56, a motor driver 57, a CPU (controlling section) 58, a memory 59, a communication driver section 60, a memory card 54, a liquid crystal display controller 61, the liquid crystal monitor (LCD) 49 as a display, the assistant-imaging optical system 47, the flash 47′, a main capacitor for flash 64, the operation section 62, and so on. The sensor section 56′ receives light flux for forming an image that enters through the shooing lens system 45. The block circuit section includes the sensor section 56′, a correlated double sampling circuit (CDS/PGA), an analog/digital converter (ADC), and a driver section. The shooting lens system 45, and the block circuit section are included in the main imaging optical system that has variable focal lengths. The signal processing section 56 processes a later-described RGB image signal. The memory 59 temporarily stores data such as image data and so on. The communication driver section 60 is used in case of communication with the outside. The memory card is detachable to a body of the camera. The liquid crystal controller 61 converts an image signal from the signal processing section 56 into a signal displayable on the LCD. The start and end of light emission of the flash 47′ are controlled by a control signal from the CPU 58.

On the basis of inputted operation information from the operation section 62, the CPU 58 controls the entire digital camera 41 based on a control program stored in a ROM.

The shooting lens, the aperture unit, and the mechanical shutter unit are driven by the motor driver 57. The motor driver 57 is controlled and driven by a drive signal from the CPU 58.

The CMOS has a light-receiving element (pixel) that is arrayed two-dimensionally, and converts an optical image formed on a light-receiving surface of the CMOS into an electrical charge. The electrical charge is outputted as an electric signal to the outside by a readout timing signal transmitted from the driver section adjacent to the CMOS. On a plurality of light-receiving elements that constitutes the CMOS, an RGB primary color filter (hereinafter, referred to as “RGB filter”) is arranged, by which an analog RGB image signal corresponding to RGB three primary colors is outputted (Note that an RGB image signal that is analog-to-digital converted is called a digital RGB image signal).

The signal processing section 56 includes a CMOS interface (hereinafter, referred to as “CMOS I/F”), a memory controller, a YUV converter, a resize processor, a display output controller, a data compressing section, and a media interface (hereinafter, referred to as “media I/F”). The CMOS I/F takes RAW-RGB data that is a digital RGB image signal. The memory controller controls an SDRAM. The YUV converter converts the taken RAW-RGB data into YUV-format image data that is displayable and recordable. The resize processor changes an image size according to the size of image data to be displayed and recorded. The display output controller controls display output of image data. The data compressing section compresses image data in a JPEG format, and so on. The media I/F writes image data on a memory card and reads out image data written on a memory card.

The signal processing section 56 functions as a first imaging section that converts an image signal of a first photographic subject image obtained by a later-described first imaging optical system into first image data, and as a second imaging section that converts an image signal of a second photographic subject image obtained by a later-described second imaging optical system into second image data.

The SDRAM stores RAW-RGB data taken in the CMOS I/F, YUV data (YUV-format image data) that is converted and processed by the YUV converter, and YUV data that is combined and processed by a YUV composite section, and additionally, stores image data such as JPEG-format image data that has been compressed and processed by the data compressing section, and so on.

YUV of the YUV data is information of brightness data (Y), and color differences (a difference (U) between the brightness data and blue color (B) data, and a difference (V) between the brightness data and red color (B) data), and is a color description type.

### [Monitoring Operation and Still Image Shooting Operation of Digital Camera]

Next, a monitoring operation and still image shooting operation of the digital camera 41 will be explained. In a case of the still image shooting operation, the digital camera 41 performs the still image shooting operation while performing the following monitoring operation.

Firstly, a user (photographer) turns the power button 43 on, and sets the shooting/playback switch dial 44 to a shooting mode. Thus, the digital camera 41 starts up with a recording mode. When the CPU 58 detects that the power button 43 is turned on and the shooting/playback switch dial 44 is set to the shooting mode, the CPU 58 outputs a control signal to the motor driver 57. Thus, the lens barrel unit 46 is moved to a photographable position. At the same time, the CMOS, the signal processing section 56, the SDRAM, the ROM, the LCD monitor 49, and so on are started up.

When the shooting lens system 45 aims at a photographic subject, light flux for forming an image that enters through the shooting lens system 45 forms an image on a light-receiving surface of the CMOS.

An electric signal corresponding to a photographic subject image from each light-receiving element of the CMOS is inputted to the A/D converter (ADC) via the CDS/PGA, and converted into 12-bit RAW-RGB data by the A/D converter.

The RAW-RGB data is taken in the CMOS I/F of the signal processing section 56, and temporarily stored in the SDRAM via the memory controller. And then the RAW-RGB data read from the SDRAM is converted into YUV data (YUV signal) in the YUV converter, sent to the SDRAM via the memory controller again, and stored as YUV data.

The YUV data read from the SDRAM via the memory controller is sent to the liquid crystal monitor (LCD) 49 via the liquid crystal display controller 61. Thus, the photographic subject image (movie) is displayed. When the monitoring operation that displays the photographic subject image on the liquid crystal monitor (LCD) 49 is performed, one frame is read out at 1/30 second by a thinning operation of the number of the pixels by the CMOS I/F.

When the monitoring operation is performed, only the photographic subject image is displayed on the liquid crystal monitor (LCD) 49, which functions as an electronic viewfinder, and the shutter button 42 is not pressed (including half-press) yet.

By display of the photographic subject image on the liquid crystal monitor (LCD) 49, the photographic subject image can be confirmed by a user (photographer). The photographic subject image (movie) can be displayed on an external TV (television) via a video cable as a TV video signal from the liquid crystal display controller 61.

The CMOS I/F of the signal processing section 56 uses the taken RAW-RGB data, and calculates an AF (Auto-Focus) evaluation value, an AE (Auto-Exposure) evaluation value, and an AWB (Auto-White Balance) evaluation value.

The AF evaluation value is calculated by use of an output integral value of a high-frequency component extraction filter, or an integral value of a brightness difference among adjacent pixels, for example. When a photographic subject is in an in-focus state, an edge part of the photographic subject is clear, and a high frequency component becomes highest.

By use of the above, when performing the AF operation (when performing an in-focus position detection operation), an AF evaluation value in each focus lens position of the shooting lens system 45 is obtained, a position where the AF evaluation value is maximum is taken as a position where the in-focus state is detected (in-focus position), and the AF operation is performed.

The AE evaluation value and the AWB evaluation value are calculated from each integrated value of the RGB value of RAW-RGB data. For example, an image plane corresponding to a light-receiving surface of the entire pixels of the CMOS is equally divided into 256 areas (horizontal 16 division, vertical 16 division), and an RGB integrated value of each area is calculated.

The CPU 58 reads out the calculated RGB integrated value, and in the AE operation, brightness of each area of the image plane is calculated, and an appropriate exposure amount is determined from brightness distribution. Based on the determined exposure amount, exposure conditions (the number of times of releasing an electronic shutter of the CMOS, an aperture value of the aperture unit, and so on) are set.

In the AWB operation, a control value of the AWB operation according to color of a light source of a photographic subject is determined from distribution of the RGB. By the AWB operation, white balance when being converted into YUV data in the YUV converter is adjusted. The AE operation and the AWB operation are sequentially operated when monitoring.

When the monitoring is performed, when the shutter button 42 is pressed (from half-press to full-press) and the still image shooting operation is started, the AF operation that is the in-focus position detection operation and the still image recording operation are performed.

That is, when the shutter button 42 is pressed (from half-press to full-press), a focus lens of the shooting lens system 45 is moved by a drive instruction from the CPU 58 to the motor driver 57, and for example, an AF operation of a contrast evaluation type, which is a so-called hill-climbing AF, is performed.

In a case where an AF (focusing) range is an entire area from infinity to a closest distance, the focus lens of the shooting lens system 45 is moved to each focus position from infinity to the closest distance or from the closest distance to infinity, and the CPU 58 reads out the AF evaluation value in each focus position calculated by the CMOS I/F. And a point where the AF evaluation value of each focus position is maximum is taken as the in-focus position, and the focus lens is moved to the in-focus position and focused.

And then the AE operation is performed, at the point of completion of exposure, the mechanical shutter unit is closed by a drive instruction from the CPU 58 to the motor driver 57, an analog RGB image signal for a still image is outputted from the light-receiving element of the CMOS, and converted into RAW-RGB data by the A/D converter (ADC), similar to the monitoring operation.

The RAW-RGB data is taken in the CMOS I/F of the signal processing section 56, converted into YUV data in the YUV converter, and stored in the SDRAM via the memory controller.

And the YUV data is read out from the SDRAM, changed to its size corresponding to the number of recording pixels in the resize processer, and compressed into image data in JPEG format or the like by the data compression section.

The compressed image data in JPEG format or the like is written back in the SDRAM, and then read out from the SDRAM via the memory controller, and stored in the memory card 54 via the media I/F.

### [Explanation of Assistant Imaging Optical System]

The assistant imaging optical system 47 functions as a first imaging optical system that is used for imaging control of the main imaging section in an assistant manner.

The main imaging optical system functions as the second imaging optical system that obtains the second photographic subject image and is set further on the telephoto side than the first imaging optical system that obtains the first photographic subject.

The assistant imaging optical system 47 is capable of imaging by use of the number of pixels approximately equal to the number of pixels used for monitoring of the main imaging optical system.

A focal length of the assistant imaging optical system 47 is within a variable range of the main imaging optical system the focal length of which is variable.

In a case where the focal length of the main imaging optical system is the same as the focal length of the assistant imaging optical system 47, an angle of view of the assistant imaging optical system 47 is set approximately equal to an angle of view of the main imaging optical system.

The assistant imaging optical system 47 sequentially performs an imaging operation separately from the main imaging optical system, and it is possible to perform monitoring display of a photographic subject image imaged by the assistant imaging optical system 47 on a display screen of the LCD 49 of the digital camera 41.

The monitoring display of the assistant imaging optical system 47 is able to be performed at the same time as the monitoring display of the main imaging optical system.

Each of FIGS. 14A and 14B is an example that displays a monitoring image G1 as the second photographic subject image by the main imaging optical system and a monitoring image G2 as the first photographic subject image by the assistant imaging optical system 47 on the display screen of the LCD 49 at the same time.

In each of FIGS. 14A and 14B, the monitoring image G1 by the main imaging optical system is displayed entirely on the display screen of the LCD 49, and the monitoring image G2 by the assistant imaging optical system 47 is displayed small as a sub-image so as to overlap the monitoring image G1 by the maim imaging optical system in a corner of the LCD 49.

FIG. 14A is a display example when the focal length of the main imaging optical system and the focal length of the assistant imaging optical system 47 are approximately equal, and the monitoring image G1 by the main imaging optical system and the monitoring image G2 by the assistant imaging optical system 47 are approximately the same. FIG. 14B is a display example when the focal length of the main imaging optical system is changed to the telephoto side, and the angle of view of the monitoring image G1 by the main imaging optical system is narrower than the angle of view of the monitoring image G2 by the assistant imaging optical system 47.

### [Explanation of Direction Display of Main Photographic Subject]

The following is an explanation of direction display of a main photographic subject such that a position of a face of a person as a main photographic subject (target) is detected from the monitoring image G2 of the assistant imaging optical system 47, and a direction where the main photographic subject exists in the monitoring image G1 by the main imaging optical system is displayed on the display screen of the LCD 49.

FIG. 15 is a flow diagram that explains steps of the direction display of the main photographic subject.

The CPU (controller) 58 performs a process that detects a face G3 of a person from a monitoring image G2 obtained by the assistant imaging optical system 47 (step S151). And the CPU 58 determines whether a face is detected or not (step S152). Here, the CPU 58 also functions as a photographic subject-determining device that determines a photographic subject from an image imaged by the assistant imaging optical system 47.

The CPU 58 performs processes of the steps S151 and S152 until a face is detected, and in a case where a face G3 is detected, the CPU 58 determines whether the number of detected faces is plural or not (step S153). In a case where the number of detected faces is one, the CPU 58 performs a process such that the detected face G3 is determined as a main photographic subject (step S154). In a case where the number of detected faces is plural, the CPU 58 performs a process as the photographic subject-determining device such that the size of each face is determined by the size of each of indicator frames G4 (See FIGS. 16A to 16C), and a largest frame of the detected indicator frames G4 is determined as a main photographic subject (step S155).

And then the CPU 58 determines whether the main photographic subject is set in the monitoring image G1 by the main imaging optical system (step S156).

The determination as to whether the main photographic subject is set in or not will be explained as follows.

The CPU 58, from a ratio between a present focal length of the main imaging optical system and the focal length of the assistant imaging optical system 47, calculates an imaging range of the monitoring image G1 by the main imaging optical system that corresponds to which area in the monitoring image G2 by the assistant imaging optical system 47, and determines a position of the main photographic subject in the monitoring image G2 by the assistant imaging optical system 47 that corresponds to which area in the monitoring image G1 by the main imaging optical system.

And then, in a case where the main photographic subject is set in the angle of view in the assistant imaging optical system 47, and the main photographic subject is not set in the angle of view in the main imaging optical system, the CPU 58 displays a guide indicator that indicates a direction where the main photographic subject exists with respect to the monitoring image G1 by the main imaging optical system on the display screen of the LCD 49 (step S157).

That is, when the angle of view of the first photographic subject image and the angle of view of the second photographic subject image are compared, and the angle of view of the second photographic subject image is narrower than the angle of view of the first photographic subject image, the CPU 58 functions as a controller that displays an imaging range corresponding to the second photographic subject image in the first photographic subject image displayed on the LCD (display) 49 by use of the indicator frame G4.

Each of FIGS. 16A to 16D is an example of a guide indicator that indicates a direction where the main photographic subject exists with respect to the monitoring image G1 by the main imaging optical system. In FIG. 16A, the guide indicator is not displayed, because the main photographic subject is set in the angle of view of the main imaging optical system.

In FIG. 16B, the main photographic subject is not set in the angle of view by the main imaging optical system. Therefore, in FIG. 16B, the guide indicator that indicates a direction where the main photographic subject exists is displayed as an arrow G5 as a pointer.

In FIG. 16B, since the main photographic subject is determined to be positioned on the right side by the monitoring image G2, in order to show that the main photographic subject exists on the right side on the display screen of the LCD 49, the arrow G5, which is right-pointing, is displayed on the right side of the display screen.

In FIG. 16B, the arrow 5 is used for the guide indicator; however, the guide indicator is not necessary to limit the arrow 5, and the guide indicator can be displayed by being shaded in a band-like manner on the right edge of the display screen as illustrated by use of reference number G6 in FIG. 16C.

In each example in FIGS. 14A, 14B, and 16A to 16C, by the CPU 58, the monitoring image G1 by the main imaging optical system and the monitoring image G2 by the assistant imaging optical system 47 are displayed on the display screen of the LCD 49 at the same time.

However, it is not always necessary to display the monitoring image G2 by the assistant imaging optical system at the same time as the monitoring image G1 by the main imaging optical system, and as illustrated in FIG. 16D, when the main photographic subject G3 becomes outside of the monitoring image G1 by the main imaging optical system, without displaying the monitoring image G2 on the display screen of the LCD 49, only the arrow G5 as the guide indicator that indicates a direction where the main photographic subject G3 exists can be displayed on the display screen of the LCD 49.

Each of FIGS. 17A and 17B is an example where a plurality of faces G3 of persons is detected. In FIGS. 17A and 17B, two faces G3, G3′ are detected, and a larger face G3 of the two faces, which is a face that faces front, is taken as a main photographic subject in this example.

As illustrated in FIG. 17A, in a case where the face G3 is set in the monitoring image G1 by the main imaging optical system, the arrow G5 is not displayed on the display screen of the LCD 49.

However, as illustrated in FIG. 17B, if the face G3′ of the two faces is set in the monitoring image G1 by the main imaging optical system and the face G3 as the main photographic subject is out of an angle of view, the arrow 5 is displayed as the guide indicator.

As explained above, in a case where the main photographic subject becomes outside of the monitoring image G1 by the main imaging optical system, a direction where the main photographic subject exists is displayed as the guide indicator; therefore, it is easy to set the main photographic subject in the angle of view again when the focal length of the main imaging optical system is set on the telephoto side and so on.

Additionally, the photographic subject-determining device includes a function that determines a face of a person; therefore, in a case where a photographic subject is a face, shooting is easy.

### Embodiment 6

FIG. 18 is a flow diagram that explains an example where a user sets a main photographic subject.

The digital camera 41 has a menu as a specifying device that specifies a main photographic subject (target). Similar to Embodiments 1 to 3, the menu is displayed on a menu screen of the LCD. As such, it is possible for a user to set whether to perform a selection of the main photographic subject by selecting the menu.

When the user selects the menu, and performs the selection of the main photographic subject (step S181), an assistant monitoring screen (monitoring image G2 by the assistant imaging optical system 47) is enlarged by the CPU 58 (step S182). FIG. 19B is an explanatory diagram where the assistant monitoring screen is enlarged.

Normally, as illustrated in FIG. 19A, the assistant monitoring screen is displayed small as a sub-image in a corner of the display screen of the LCD 49.

When the user performs the selection of the main photographic subject, as illustrated in FIG. 19B, the assistant monitoring screen is enlarged and displayed, and it is easy for a user to select the main photographic subject.

For example, the main photographic subject is selected by displaying a cross-shaped cursor G7 or the like to specify a main photographic subject on the monitoring image G2 by the assistant imaging optical system 47, and pressing an up-down-right-left key 55′ (See FIG. 12C) to move the cross-shaped cursor G7 or the like (step S183).

When the user finishes performing the selection of the main photographic subject, the display of the assistant monitoring screen is returned to an original size illustrated in FIG. 19A (step S184).

After the user has selected the main photographic subject, while the main photographic subject G3 is set in an angle of view of the assistant imaging optical system 47, the CPU 58 locks the main photographic subject G3, and continues to obtain its position. And the CPU 58 determines whether the main photographic subject G3 is set in an angle of view of the main imaging optical system or not by the same operation as that in Embodiment 5 (step S185).

And then, in a case where in the assistant imaging optical system 47, the main photographic subject G3 is set in the angle of view, and in the main imaging optical system, the main photographic subject G3 is not set in the angle of the view, an arrow (pointer) G5 that indicates a direction where the main photographic subject G3 exists is displayed as a guide indicator by the CPU 58, with respect to the monitoring image G1 of the main imaging optical system (step S186).

According to Embodiment 6, it is convenient for a user to select and specify a desired main photographic subject from the monitoring image G2 imaged by the assistant imaging optical system 47. Additionally, since the monitoring image G2 is enlarged and displayed on the display screen during the selection of the main photographic subject by the user, it is easy to perform selection of a main photographic subject.

Thus, in a display method according to Embodiment 5 and Embodiment 6, a step of displaying a second photographic subject image obtained by a second imaging optical system, a step of determining a photographic subject as a target by a photographic subject-determining device from a first photographic subject image, and a step of displaying a pointer that indicates a direction where the target exists on a display when at least a part of the target becomes outside of the second photographic subject image are at least performed.

According to the embodiments of the present invention, it is possible to set a desired photographic subject in a range of an angle of view in high-magnification shooting.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. An imaging apparatus comprising:
a first imaging optical system that obtains a first photographic subject image;
a second imaging optical system that is capable of obtaining a second photographic subject image which is more telephoto than the first photographic subject image obtained by the first imaging optical system;
a first imaging section that converts an image signal of the first photographic subject image obtained by the first imaging optical system into first image data;
a second imaging section that converts an image signal of the second photographic subject image obtained by the second imaging optical system into second image data;
a display that displays the first photographic subject image by the first image data and the second photographic subject image by the second image data; and
a controller that controls the display such that an indicator frame that indicates an imaging range of the second photographic subject image is displayed in the first photographic subject image displayed on the display.

2. The imaging apparatus according to claim 1, wherein when the second photographic subject image is displayed on the display, the controller controls the display such that the first photographic subject image is displayed as a sub-image, and an imaging range corresponding to the second photographic subject image is displayed in an area where the sub-image is displayed as an indicator frame on the display.

3. The imaging apparatus according to claim 1, further comprising:
a photographic subject-determining device that determines a photographic subject as a target from the first photographic subject image obtained by the first imaging optical system,
wherein the controller locks the target that exists in the first photographic subject image determined by the photographic subject-determining device, and controls the display such that a pointer that indicates a direction where the target exists is displayed on the display when at least a part of the target becomes outside of the second photographic subject image.

4. The imaging apparatus according to claim 1, wherein in the first imaging optical system and the second imaging optical system, at least the second imaging optical system includes an optical zoom lens.

5. The imaging apparatus according to claim 1, wherein a fixed-magnification imaging optical system constitutes each of the first imaging optical system and the second imaging optical system, and at least the second photographic subject image obtained by the second imaging optical system is an enlarged image by digital zoom.

6. The imaging apparatus according to claim 4, wherein when an angle of view of the first photographic subject image and an angle of view of the second photographic subject image are compared, and the angle of view of the second photographic subject image is narrower than the angle of view of the first photographic subject image, the controller controls the display such that an indicator frame that indicates an imaging area corresponding to the second photographic subject image is displayed in the first photographic subject image displayed on the display.

7. The imaging apparatus according to claim 3, wherein the photographic subject-determining device detects a face of a person from the first photographic subject obtained by the first imaging optical system, and determines the face as the target.

8. The imaging apparatus according to claim 3, wherein the photographic subject-determining device includes a specifying device by which a user specifies the photographic subject as the target from a monitoring image as the first photographic subject image obtained by the first imaging optical system.

9. The imaging apparatus according to claim 8, wherein the controller controls the display such that the monitoring image obtained by the first imaging optical system is enlarged and displayed on the display while the user operates the specifying device.

10. A method of display used for an imaging device including:
a first imaging optical system that obtains a first photographic subject image;
a second imaging optical system that is capable of obtaining a second photographic subject image which is more telephoto than the first photographic subject image obtained by the first imaging optical system;
a first imaging section that converts an image signal of the first photographic subject image obtained by the first imaging optical system into first image data;
a second imaging section that converts an image signal of the second photographic subject image by the first imaging optical system into second image data;
a display that displays the second photographic subject image by the second image data;
a controller that controls the display such that an indicator frame that indicates an imaging range of the second photographic subject image is displayed on the first photographic subject image; and
a photographic subject-determining device that determines a photographic subject as a target from the first image data obtained by the first imaging optical system,
the method comprising the steps of:
displaying the second photographic subject image obtained by the second imaging optical system;
determining a photographic subject as a target from the first photographic subject image by the photographic subject-determining device; and
displaying a pointer such that when at least a part of the target becomes outside of the second photographic subject image, the pointer that indicates a direction where the target exists is displayed on the display.
